(19) United States
(12) Patent Application Publication
(10) Pub. No.: US 2010/0018470 A1
(43) Pub. Date: Jan. 28, 2010

(54) Submersible Offshore Marine Aquaculture Apparatus

(76) Inventor: Dong-Joo Kim, Seoul (KR)

Correspondence Address: SUTHERLAND ASBILL & BRENNAN LLP, 999 PEACHTREE STREET, N.E., ATLANTA, GA, 30309, US

(21) Appl. No.: 12/474,639

(22) Filed: May 29, 2009

(30) Foreign Application Priority Data
Jul. 24, 2008 (KR) 1020080072337

(51) Int. Cl. A01K 61/00

(52) U.S. Cl. 119/223

(57) ABSTRACT

A submersible offshore marine aquaculture apparatus comprises a lower frame configured to suspend plumb bobs therefrom and to form a lower shape of the apparatus; and an upper frame configured to form an upper shape of the apparatus, and to support nets together with the lower frame. The upper frame includes a rim structure having an inner space to accommodate seawater or air therein, a fixed buoyant body disposed at the inner space of the rim structure so as to maintain a constant buoyancy (B0), and one or more valves configured to open and close the inner space of the rim structure so as to vary a buoyancy (B1) of the rim structure.

### CROSS REFERENCES TO RELATED APPLICATIONS

Pursuant to 35 U.S.C. §119(a), this application claims the benefit of earlier filing date and right of priority to Korean Application 10-2008-0072337, filed on Jul. 24, 2008, the contents of which is incorporated by reference herein in its entirety.

### BACKGROUND

1. Field of the Invention

The present invention relates to an offshore underwater fish cage for farming fish capable of breeding fisheries, etc. in the sea away from the shore.

2. Background of the Invention

A fish farming in the inshore water where the sea and the land meet has prevailed for a long time due to easy access and management conditions.

Inshore aquaculture sites are mainly installed at places surrounded by bays or islands for facilitation of protection from the typhoon or tidal currents.

However, excessive nutritive salts are being introduced into the sea due to waste water from homes, industrial waste water, feedstuffs for breeding, etc. as the population increases at the coast and aquaculture sites are intensively located in the inshore water. These excessive nutritive salts cause eutrophication in a coastal ecosystem, thereby resulting in shore water pollution, harmful red tide, seashell poison, etc. This may badly influence on a marine ecosystem as well as the aquaculture sites.

In order to solve these problems, has been proposed an offshore farming method implemented in an offshore water, a relatively clean area.

However, since the offshore is exposed to tidal currents or severe wind waves, farming equipment that can be protected from the bad conditions is required.

### SUMMARY OF THE INVENTION

Therefore, an object of the present invention is to provide a submersible offshore marine aquaculture apparatus capable of maintaining a safe farming system in offshore water exposed to bad conditions such as wind waves.

Another object of the present invention is to provide a submersible offshore marine aquaculture apparatus capable of having a controllable buoyancy so as to float on the surface of water or in water.

To achieve these and other advantages and in accordance with the purpose of the present invention, as embodied and broadly described herein, the present invention provides a submersible offshore marine aquaculture apparatus, comprising: a lower frame configured to suspend plumb bobs therefrom and to form a lower shape of the apparatus; and an upper frame configured to form an upper shape of the apparatus, and to support nets together with the lower frame. The upper frame includes a rim structure having an inner space to accommodate seawater or air therein, a fixed buoyant body disposed at the inner space of the rim structure so as to maintain a constant buoyancy (B₀), and one or more valves configured to open and close the inner space of the rim structure so as to vary a buoyancy (B₁) of the rim structure.

The lower frame may be assembled by coupling a plurality of steel pipes to each other to form a rim.

The rim structure may be assembled by coupling a plurality of resin pipes having a first diameter to each other.

The fixed buoyant body may be assembled by coupling a plurality of resin pipes to each other, the resin pipes having a second diameter smaller than the first diameter.

An inner space of the fixed buoyant body may be sealed with air filled therein.

The fixed buoyant body may be formed in plurality in number.

The valves may include a seawater valve disposed at a lower side of the rim structure and configured to control seawater to flow in and out of the rim structure, and an air valve disposed at an upper side of the rim structure and configured to control air to flow in and out of the rim structure.

The seawater valve and the air valve may be disposed at a plurality of positions of the rim structure in a circumferential direction.

A partition net may be further comprised between the upper frame and the lower frame.

In an embodiment of the present invention, the plumb bobs, the upper frame, the rim structure, and the fixed buoyant body may be formed to have a volume and a weight that can satisfy the following formulas (1)˜(3), respectively.

B0+B1>W1+W2+W3 (when the upper frame floats on the surface of the sea) (1)

B0>W1+W2 (when the submersible offshore marine aquaculture apparatus floats in water having a predetermined depth) (2)

W3>B0 (W1+W2)>0 (when the submersible offshore marine aquaculture apparatus floats in water having a predetermined depth) (3)

Here, B₀ indicates a buoyancy of the fixed buoyant body. B₁ indicates a buoyancy of the rim structure. W₁ indicates a weight of the upper frame. W₂ indicates a weight of the lower frame, and W₃ indicates a total weight of the plumb bobs.

The submersible offshore marine aquaculture apparatus according to the present invention has the following effects.

Firstly, the rim structure of the upper frame maintains the frame (outline) of the submersible offshore marine aquaculture apparatus from wind waves. And, an amount of sea water or air inside the inner space of the upper frame is controlled by the valve, thereby varying a buoyancy of the upper frame. Accordingly, the submersible offshore marine aquaculture apparatus can have a controllable height.

Secondly, since the fixed buoyant body has a constant buoyancy not varied according to a depth of the sea, it can have more excellent durability and controllable functions than other substances having a variable volume such as styrofoam.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a perspective view of a submersible offshore marine aquaculture apparatus according to the present invention;

FIG. 2 is a perspective view of a lower frame of the submersible offshore marine aquaculture apparatus according to the present invention;

FIG. 3 is a perspective view showing a partial section of an upper frame of the submersible offshore marine aquaculture apparatus according to the present invention;

FIGS. 4A and 4B are sectional views of the upper frame according to the present invention;

FIGS. 5A and 5B are side views of the submersible offshore marine aquaculture apparatus, which show a current usage state, in which:

FIG. 5A shows a state that the submersible offshore marine aquaculture apparatus floats on the surface of water; and

FIG. 5B shows a state that the submersible offshore marine aquaculture apparatus floats in water; and

FIG. 6 is a side view of the submersible offshore marine aquaculture apparatus according to another example of the present invention.

### DETAILED DESCRIPTION OF THE INVENTION

Description will now be given in detail of the present invention, with reference to the accompanying drawings.

Hereinafter, a submersible offshore marine aquaculture apparatus according to the present invention will be explained in more detail.

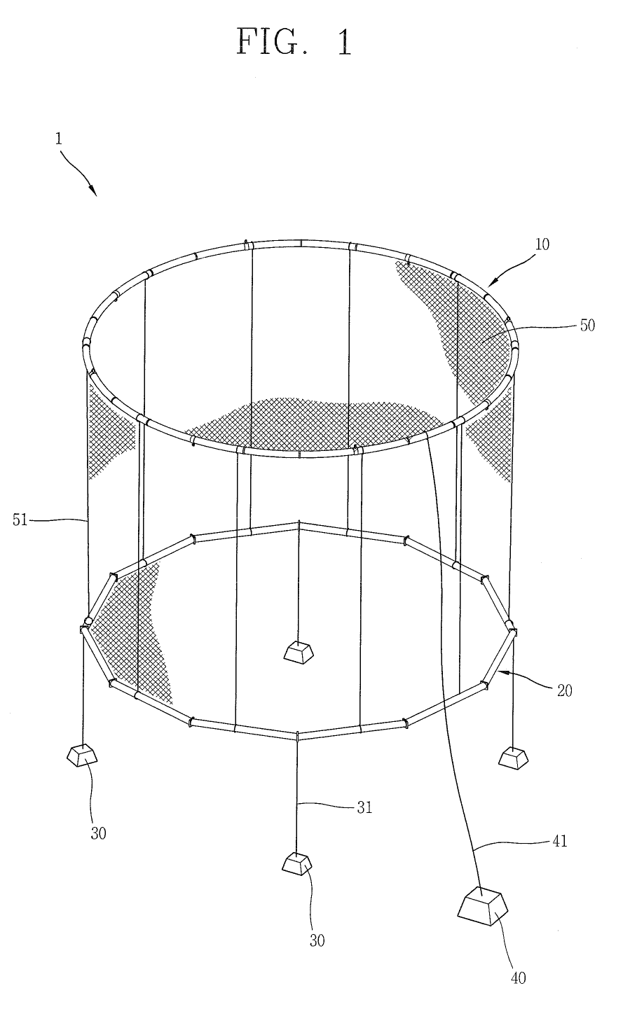

FIG. 1 is a perspective view of a submersible offshore marine aquaculture apparatus according to the present invention.

The submersible offshore marine aquaculture apparatus 1 comprises an upper frame 10, a lower frame 20, nets 50, plumb bobs 30, etc. The plumb bobs 30 are suspended from a plurality of portions of the lower frame 20 along a circumferential direction by first ropes 31. And, the upper frame 10 and the lower frame 20 are connected to each other by second ropes 51. The nets 50 are supported by the upper frame 10, the lower frame 20, and the second ropes 51, thereby providing a space to farm fisheries, etc.

The upper frame 10 and the lower frame 20 form the size or appearance of the submersible offshore marine aquaculture apparatus 1. And, the upper frame 10 and the lower frame 20 are formed in a nearly circular shape so that fisheries, etc. can easily circle along the edges thereof.

The lower frame 20 and the plumb bobs 30 occupy most of weight of the submersible offshore marine aquaculture apparatus 1. And, the upper frame 10 provides a buoyancy large enough for the submersible offshore marine aquaculture apparatus 1 to float on the surface of water. Accordingly, the second ropes 51 receive a tension in water by combination between the buoyancy of the upper frame 10 and the weights of the lower frame 20 and the plumb bobs 30. As a result, the submersible offshore marine aquaculture apparatus 1 is in a unfolded state in water as shown in FIG. 1. The submersible offshore marine aquaculture apparatus 1 is in water or floats on the surface of water having a depth more than several tens of meters.

The submersible offshore marine aquaculture apparatus 1 is restricted by an anchor 40 and a third rope 41 so as to be prevented from moving away due to tidal currents or strong wind waves.

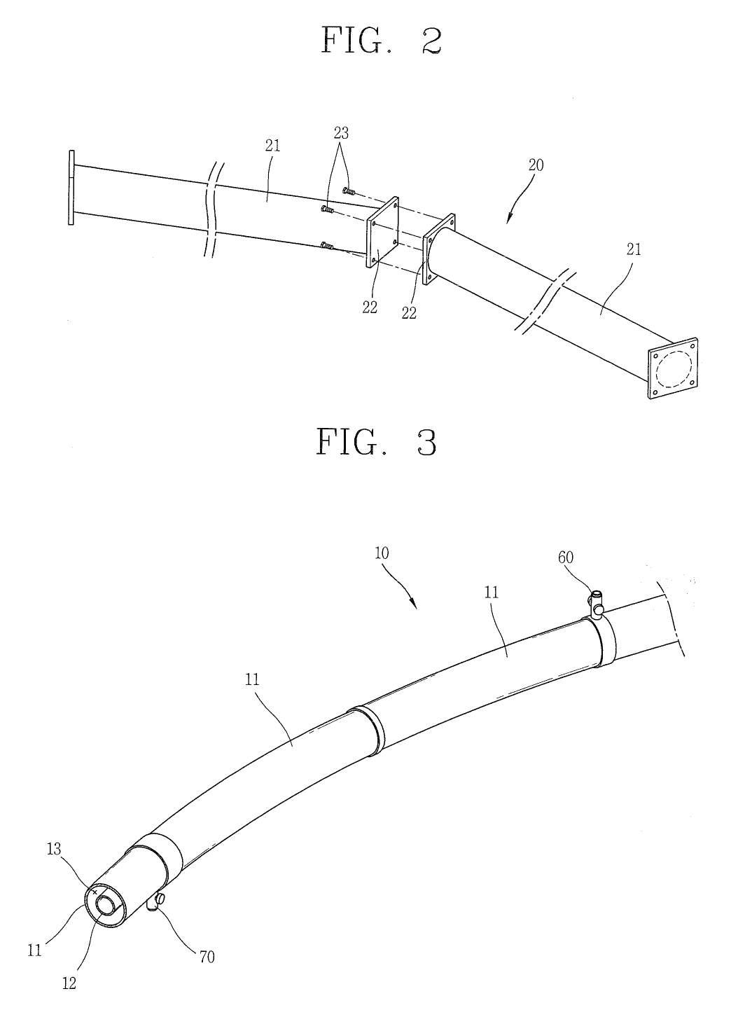

FIG. 2 is a perspective view of the lower frame 20 of the submersible offshore marine aquaculture apparatus 1 according to the present invention. Referring to FIG. 2, the lower frame 20 is formed in a rim shape as a plurality of steel pipes 21 having a predetermined length are coupled to each other. Each of the steel pipes 21 has both ends to which flanges 22 are attached. The flanges allow the steel pipes 21 to be assembled to each other by a coupling means such as screws 23. The flanges 22 may be attached to both ends of each steel pipe 21 with an inclination angle toward the center so that the steel pipes 21 can be assembled to each other in a rim shape. The flanges 22 may be sealed to both ends of each steel pipe 21 by a welding process, etc. so as to prevent seawater from being introduced into the steel pipe 21.

The steel pipes 21 may be formed of alloy steel such as stainless steel, or plated steel having an excellent corrosion resistance.

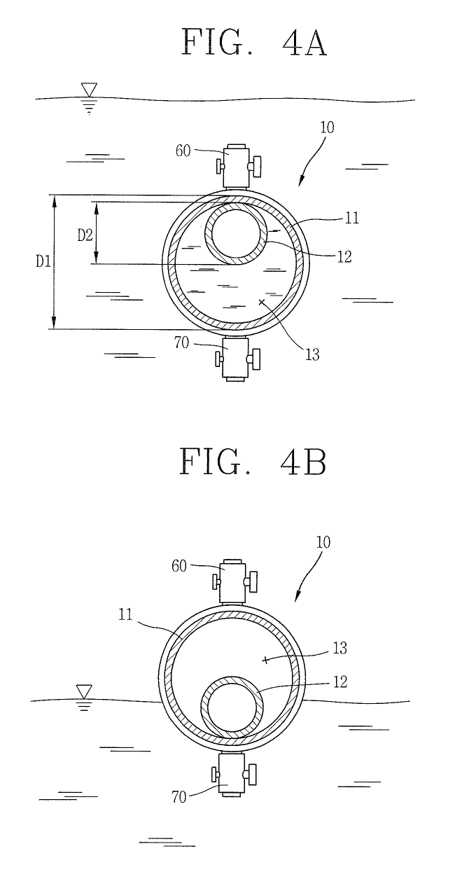

FIG. 3 is a perspective view showing a partial section of the upper frame 10 of the submersible offshore marine aquaculture apparatus 1 according to the present invention.

Referring to FIG. 3, the upper frame 10 includes a rim structure 11 having an inner space 13 to accommodate seawater or air therein, and a fixed buoyant body 12 disposed at the inner space of the rim structure 11.

The inner space 13 of the rim structure 11 is filled with seawater or air according to circumstances of the submersible offshore marine aquaculture apparatus 1. The rim structure 11 may be implemented by coupling a plurality of resin pipes to each other. The resin pipes may be bonded to each other by a thermal hardening process, etc.

The rim structure 11 is a little deformed due to elasticity of the resin pipes when strong wind and waves occur on the surface of water. Accordingly, an impact applied to the submersible offshore marine aquaculture apparatus 1 can be attenuated, and the entire shape of the submersible offshore marine aquaculture apparatus 1 can be maintained.

The fixed buoyant body 12 may be formed of resin pipes having a constant volume differently from Styrofoam, etc., and may be formed by coupling a plurality of resin pipes to each other like the rim structure 11.

The fixed buoyant body 12 may be implemented in the form of a double pipe together with the rim structure 11. The rim structure 11 is formed to have a first diameter (D1), whereas the fixed buoyant body 12 is formed to have a second diameter (D2) smaller than the first diameter (D1). An inner space of the fixed buoyant body 12 is sealed with air filled therein. Accordingly, even if a water pressure is applied to the submersible offshore marine aquaculture apparatus 1 in a state that the upper frame 10 floats on the surface of water, a volume of the fixed buoyant body 12 is scarcely changed. This may allow the fixed buoyant body 12 to have a constant buoyancy.

Referring to FIG. 3, one fixed buoyant body 12 is accommodated in the rim structure 11. However, it is also possible that a plurality of fixed buoyant body 12 having a small diameter are accommodated in the rim structure 11.

One or more valves 60 and 70 configured to open and close the inner space 13 of the rim structure 11 so as to vary a buoyancy of the rim structure 11 are disposed on an outer side of the rim structure 11.

The valves include a seawater valve 70 disposed at a lower side of the rim structure 11 and configured to control seawater to flow in and out of the rim structure 11, and an air valve 60 disposed at an upper side of the rim structure 11 and configured to control air to flow in and out of the rim structure 11. The seawater valve 70 and the air valve 60 are disposed at a plurality of positions of the rim structure 11 in a circumferential direction.

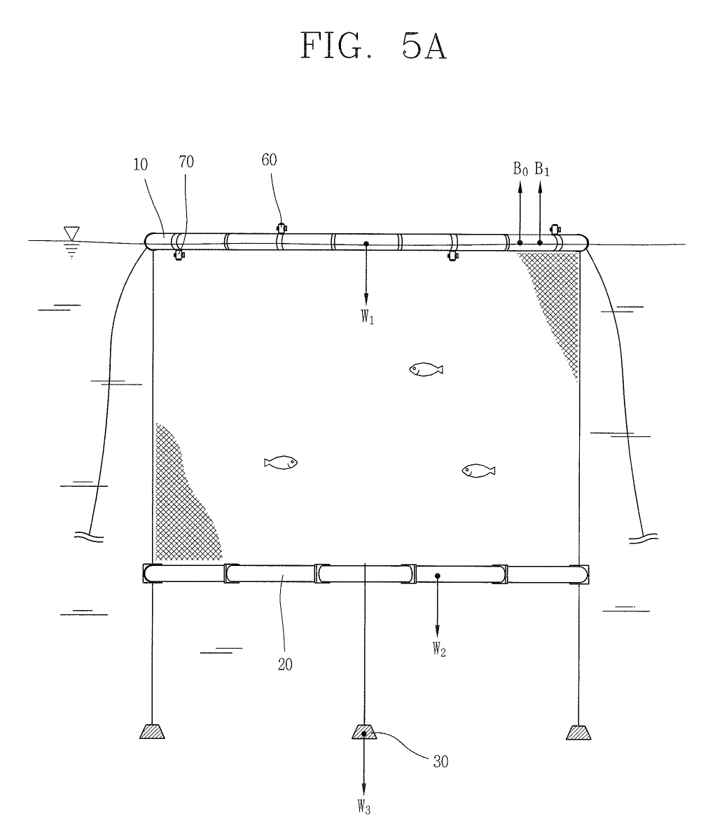

FIGS. 4A and 4B are sectional views of the upper frame 10 according to the present invention.

Referring to FIG. 4A, in order to allow the upper frame 10 to float in water, seawater is introduced into the inner space 13 of the rim structure 11. In this case, the fixed buoyant body 12 is positioned on an inner upper end of the rim structure 11 due to its buoyancy. And, since the fixed buoyant body 12 has a nearly constant volume, its buoyancy is constantly maintained. However, the fixed buoyant body 12 may be fixedly formed in the rim structure 11. In this case, a position of the fixed buoyant body 12 is not moved.

In order to float the submersible offshore marine aquaculture apparatus 1 which is in a state of FIG. 4A on the surface of water, the seawater valve 70 is opened, and compression air is injected into the rim structure 1 through the air valve 60. Accordingly, the compression air pushes seawater inside the rim structure 11 to outside of the rim structure 11 through the seawater valve 70. As a result, the submersible offshore marine aquaculture apparatus 1 floats on the surface of water due to an increased buoyancy of the rim structure 11. Once the upper frame 10 floats on the surface of water, the injection of the compression air is stopped. At the same time, the air valve 60 and the seawater valve 70 are closed, which is shown in FIG. 4B. Referring to FIG. 4B, since the seawater inside the rim structure 11 has been replaced by the air, the fixed buoyant body 12 is positioned on a lower end of the rim structure 11.

In order to submerge the submersible offshore marine aquaculture apparatus 1 which is in a state of FIG. 4B, both the air valve 60 and the seawater valve 70 are opened. As a result, seawater is introduced into the rim structure 11 through the seawater valve 70 positioned at a lower portion of the rim structure 11, thereby outwardly pushing the air inside the rim structure 11 through the air valve 60. This causes the upper frame 10 to have a decreased buoyancy, and the submersible offshore marine aquaculture apparatus 1 to sink in water due to the weights of the lower frame 20 and the plumb bobs 30.

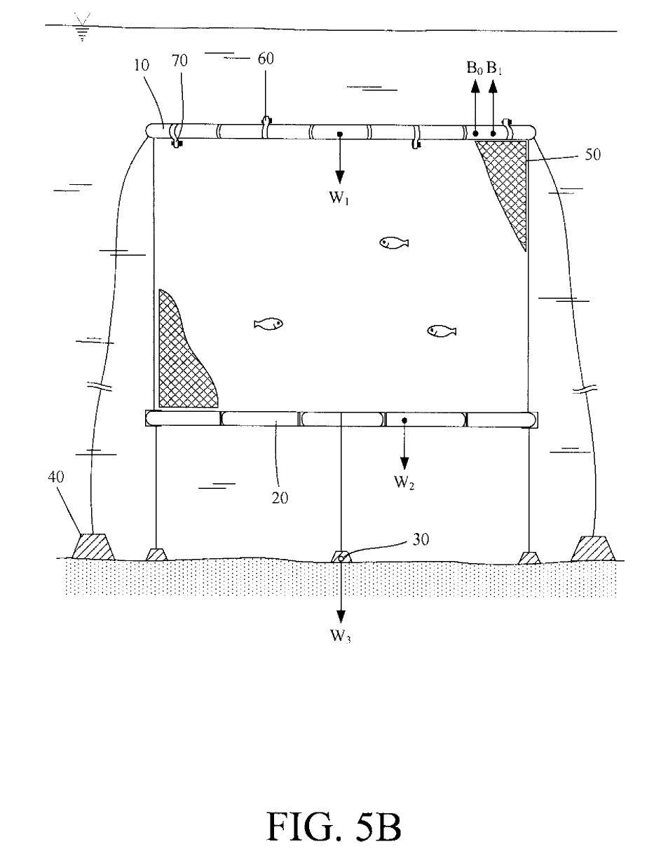

FIGS. 5A and 5B are side views of the submersible offshore marine aquaculture apparatus, which show a current usage state.

FIG. 5A shows a state that the submersible offshore marine aquaculture apparatus 1 floats on the surface of water for repair, or for introduction of child fish, or for gathering of adult fish.

In order to allow the submersible offshore marine aquaculture apparatus 1 to float on the surface of water, buoyancy conditions have to satisfy the following formula 1.

B0+B1>W1+W2+W3 <Formula 1>

Here, B0 indicates a buoyancy of the fixed buoyant body 12, B1 indicates a buoyancy of the rim structure 11. W1 indicates a weight of the upper frame 10. W2 indicates a weight of the lower frame 20, and W3 indicates a total weight of the plumb bobs 30. A buoyancy of the submersible offshore marine aquaculture apparatus 1 mainly occurs at the upper frame 10.

More concretely, in order to float the upper frame 11 on the surface of water, a buoyancy of the upper frame 10 (i.e., the sum of a buoyancy (B1) of the rim structure 11 and a buoyancy (B0) of the fixed buoyant body 12) have to be larger than the sum of a weight (W1) of the upper frame 10, a weight (W2) of the lower frame 20, and a total weight (W3) of the plumb bobs 30.

FIG. 5B shows a state that the submersible offshore marine aquaculture apparatus 1 floats in water. In order to allow the submersible offshore marine aquaculture apparatus 1 to float in water, buoyancy conditions have to satisfy the following formulas 2 and 3.

B0>W1+W2 <Formula 2>

W3>B0−(W1+W2)>0 <Formula 3>

That is, in water, the inner space of the rim structure 11 is filled with seawater. Accordingly, the submersible offshore marine aquaculture apparatus 1 floats in water only by the buoyancy (B₀) of the fixed buoyant body 12. Since the shape of the submersible offshore marine aquaculture apparatus 1 has to be maintained, the buoyancy (B₀) of the fixed buoyant body 12 has to be larger than the sum of the weight (W₁) of the upper frame 10 and the weight (W₂) of the lower frame 20 (refer to the formula 2).

On the contrary, when the buoyancy (B₀) of the fixed buoyant body 12 is too excessive, the submersible offshore marine aquaculture apparatus 1 may float on the surface of water or move. Accordingly, the buoyancy (B₀) of the fixed buoyant body 12 has to be smaller than the sum of the weight (W₁) of the upper frame 10, the weight (W₂) of the lower frame 20, and the total weight (W₃) of the plumb bobs 30 (refer to the formula 3).

The sizes, volumes, or weights of the plumb bobs 30, the lower frame 20, the rim structure 11 and the fixed buoyant body 12 have to be designed so as to satisfy the conditions of the formulas 1 to 3.

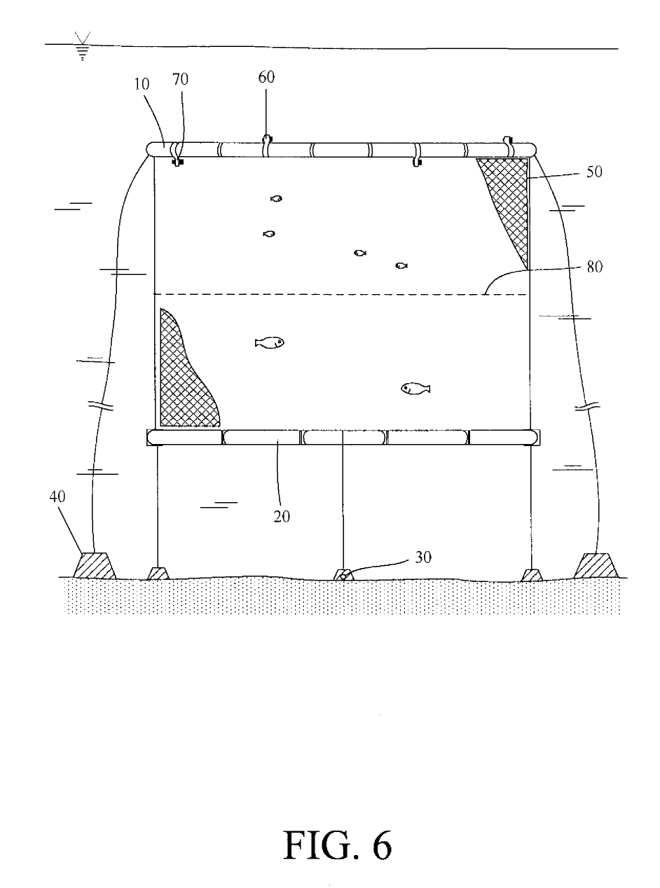

FIG. 6 is a side view of the submersible offshore marine aquaculture apparatus according to another example of the present invention.

Referring to FIG. 6, a partition net 80 is formed between the upper frame 10 and the lower frame 20. In this case, child fish is allowed to grow in an upper chamber of the partition net 80, whereas adult fish is allowed to grow in a lower chamber of the partition net 80.

The foregoing embodiments and advantages are merely exemplary and are not to be construed as limiting the present disclosure. The present teachings can be readily applied to other types of apparatuses. This description, is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A submersible offshore marine aquaculture apparatus, comprising:
a lower frame configured to suspend plumb bobs therefrom and to form a lower shape of the apparatus; and
an upper frame configured to form an upper shape of the apparatus, for supporting nets together with the lower frame,
wherein the upper frame comprises:
a rim structure having an inner space to accommodate seawater or air therein;
a fixed buoyant body disposed at the inner space of the rim structure, and configured to have a constant buoyancy (B₀) by maintaining a constant volume; and
a plurality of valves configured to open and close the inner space of the rim structure so as to vary a buoyancy (B₁) of the rim , wherein the plurality of valves comprise:
a plurality of seawater valves disposed at a plurality of respective positions on a lower side of the rim structure in a circumferential direction, and configured to control seawater to flow in and out of the rim structure; and
a plurality of air valves disposed at a plurality of respective positions on an upper side of the rim structure in a circumferential direction, and configured to control air to flow in and out of the rim structure.

2. The submersible offshore marine aquaculture apparatus of claim 1, wherein the lower frame is assembled by coupling a plurality of steel pipes to each other in the form of a rim.

3. The submersible offshore marine aquaculture apparatus of claim 1, wherein the rim structure is assembled by coupling a plurality of resin pipes having a first diameter to each other.

4. The submersible offshore marine aquaculture apparatus of claim 3, wherein the fixed buoyant body is assembled by coupling a plurality of resin pipes to each other, the resin pipes having a second diameter smaller than the first diameter.

5. The submersible offshore marine aquaculture apparatus of claim 3, wherein an inner space of the fixed buoyant body is sealed with air filled therein.

6. (canceled)

7. (canceled)

8. (canceled)

9. The submersible offshore marine aquaculture apparatus of claim 1, further comprising a partition net disposed between the upper frame and the lower frame.
